(19) United States
(12) Patent Application Publication
(10) Pub. No.: US 2022/0162852 A1
(43) Pub. Date: May 26, 2022

(54) BOOTH

(71) Applicant: FUJIFILM BUSINESS INNOVATION CORP., Tokyo (JP)

(72) Inventors: Shigenaga FUJIMURA, Kanagawa (JP); Kota NAKAYAMA, Kanagawa (JP); Ryuichi SHIRAISHI, Kanagawa (JP); Takahiro OKAYASU, Kanagawa (JP); Kengo TOKUCHI, Kanagawa (JP)

(73) Assignee: FUJIFILM BUSINESS INNOVATION CORP., Tokyo (JP)

(21) Appl. No.: 17/372,974

(22) Filed: Jul. 12, 2021

(30) Foreign Application Priority Data
Nov. 20, 2020 (JP) 2020-192872
Jan. 13, 2021 (JP) 2021-003214

(51) Int. Cl. E04B 9/00; A62C 35/02; A62C 3/02

(52) U.S. Cl. CPC E04B 9/006; A62C 3/0214; A62C 35/02

(57) ABSTRACT

A booth with a ceiling and an inside space includes: a fire extinguisher that is positioned in an opening portion formed in the ceiling, has a fire extinguisher main body storing a fire-extinguishing agent, and sprays the fire-extinguishing agent into the inside space; and a support tool that is disposed on the upper surface of the ceiling so as to surround the opening portion and has an opening being smaller than the maximum outside diameter of the fire extinguisher main body and corresponding to the outside shape of at least a portion of the fire extinguisher main body. The fire extinguisher main body is supported by the support tool from the lower side in the gravitational direction.

### CROSS-REFERENCE TO RELATED APPLICATIONS

This application is based on and claims priority under 35 USC 119 from Japanese Patent Application No. 2020-192872 filed Nov. 20, 2020 and Japanese Patent Application No. 2021-003214 filed Jan. 13, 2021.

### BACKGROUND

### (i) Technical Field

The present disclosure relates to a booth having a fire-extinguishing facility.

### (ii) Related Art

There are automatic fire extinguishers provided, for example, at the ceiling in a room and configured to automatically squirt, in rays, a fire-extinguishing agent stored in a main body when the temperature in the room rises to a predetermined degree due to the breakout of a fire. In such fire extinguishers, an automatic fire extinguisher having a thermosensitive element on a surface of a main body has been known (Japanese Unexamined Utility Model Registration Application Publication No. 56-146959). The fire extinguisher brings an alarm into operation based on a detection result of the thermosensitive element, when the temperature in the room reaches a certain degree lower than a predetermined degree and higher than a normal room temperature.

### SUMMARY

Aspects of non-limiting embodiments of the present disclosure relate to a facility enabling the simple installation of a fire extinguisher configured to spray a fire-extinguishing agent into an inside space of a booth.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a booth with a ceiling and an inside space, including: a fire extinguisher that is positioned in an opening portion formed in the ceiling, has a fire extinguisher main body storing a fire-extinguishing agent, and sprays the fire-extinguishing agent into the inside space; and a support tool that is disposed on the upper surface of the ceiling so as to surround the opening portion and has an opening being smaller than the maximum outside diameter of the fire extinguisher main body and corresponding to the outside shape of at least a portion of the fire extinguisher main body. The fire extinguisher main body is supported by the support tool from the lower side in the gravitational direction.

### BRIEF DESCRIPTION OF THE DRAWINGS

An exemplary embodiment of the present disclosure will be described in detail based on the following figures, wherein:

FIG. 1 is a perspective view of a related part of the inner configuration of a booth according to the present exemplary embodiment;

FIG. 2 is a plan view illustrating how the booth is installed;

FIGS. 3A to 3C illustrate the booth, that is, FIG. 3A is a partially sectional front view of the inner configuration of the booth, FIG. 3B is a side view of the booth, and FIG. 3C is a plan view;

FIGS. 4A to 4C schematically illustrate the air circulation in the entire space of the booth;

FIGS. 5A and 5B illustrate the structure of a fire extinguisher, that is, FIG. 5A is a side view, and FIG. 5B is a plan view;

FIGS. 6A and 6B illustrate examples of a hollow cylindrical support tool, that is, FIG. 6A is a perspective view of an example, and FIG. 6B is a perspective view of an example of a hollow cylindrical support tool divided into plural portions;

FIGS. 7A and 7B illustrate examples of a support tool constituted by a polygonal body, that is, FIG. 7A is a perspective view of an example, and FIG. 7B is a perspective view of another example;

FIGS. 8A and 8B are perspective views illustrating examples of a box-shaped support tool, that is, FIG. 8A is a perspective view of an example, and FIG. 8B is a perspective view of an example of a box-shaped support tool divided into plural portions;

FIGS. 9A and 9B are perspective views illustrating examples of how a support tool is attached to the upper surface of a ceiling;

FIGS. 10A and 10B illustrate a structure for fixing the fire extinguisher, that is, FIG. 10A is a schematic vertical sectional view, and FIG. 10B is a schematic plan view;

FIG. 11A to 11C illustrate the stability of the fixation of the fire extinguisher in relation to the shape of a fire extinguisher main body and the size of the opening of a support tool;

FIG. 12 is a perspective view of an example of a fixing tool;

FIGS. 13A and 13B illustrate a structure for fixing the fire extinguisher, according to Modification 1, that is, FIG. 13A is a schematic vertical sectional view, and FIG. 13B is a schematic plan view;

FIGS. 14A and 14B illustrate a spacer as a fixing tool and an E-shaped stopper ring, respectively;

FIGS. 15A and 15B illustrate a structure for fixing the fire extinguisher by using the E-shaped stopper ring, that is, FIG. 15A is a schematic vertical sectional view, and FIG. 15B is a schematic plan view;

FIGS. 16A and 16B are perspective views of fixing tools according to Modification 2;

FIGS. 17A and 17B illustrate a structure for fixing the fire extinguisher, according to Modification 2, that is, FIG. 17A is a schematic vertical sectional view, and FIG. 17B is a schematic plan view;

FIGS. 18A and 18B illustrate a structure for fixing the fire extinguisher, according to Modification 3, that is, FIG. 18A is a schematic vertical sectional view, and FIG. 18B is a schematic plan view;

FIG. 19 is a schematic vertical sectional view of a structure for fixing the fire extinguisher, according to Modification 4;

FIGS. 20A and 20B illustrate a structure for fixing the fire extinguisher, according to Modification 5, that is, FIG. 20A is a schematic vertical sectional view, and FIG. 20B is a schematic plan view;

FIGS. 21A and 21B illustrate a structure for fixing the fire extinguisher, according to Modification 6, that is, FIG. 21A is a schematic vertical sectional view, and FIG. 21B is a schematic plan view;

FIG. 22 is a perspective view of a structure for fixing the fire extinguisher, according to Modification 7;

FIG. 23 is a perspective view illustrating the disposition of a surrounding frame for the fire extinguisher;

FIG. 24 is a perspective view illustrating the disposition of a surrounding frame for the fire extinguisher, according to a modification;

FIG. 25 is a perspective view illustrating the disposition of a covering member covering the fire extinguisher; and

FIG. 26 is a perspective view illustrating the disposition of a covering member covering the fire extinguisher, according to a modification.

### DETAILED DESCRIPTION

Next, the present disclosure will be described in further detail with reference to the drawing, by way of an exemplary embodiment and specific examples below. However, the present disclosure is not limited to the exemplary embodiment and the specific examples.

Note that the drawings to be referred to in the following description are schematically illustrated, and note that, for example, dimensional ratios of constituents differ from those of actual constituents. For facilitating understanding, illustration of the members other than the members necessary for the description will appropriately be omitted.

### (1) Overall Configuration of Booth

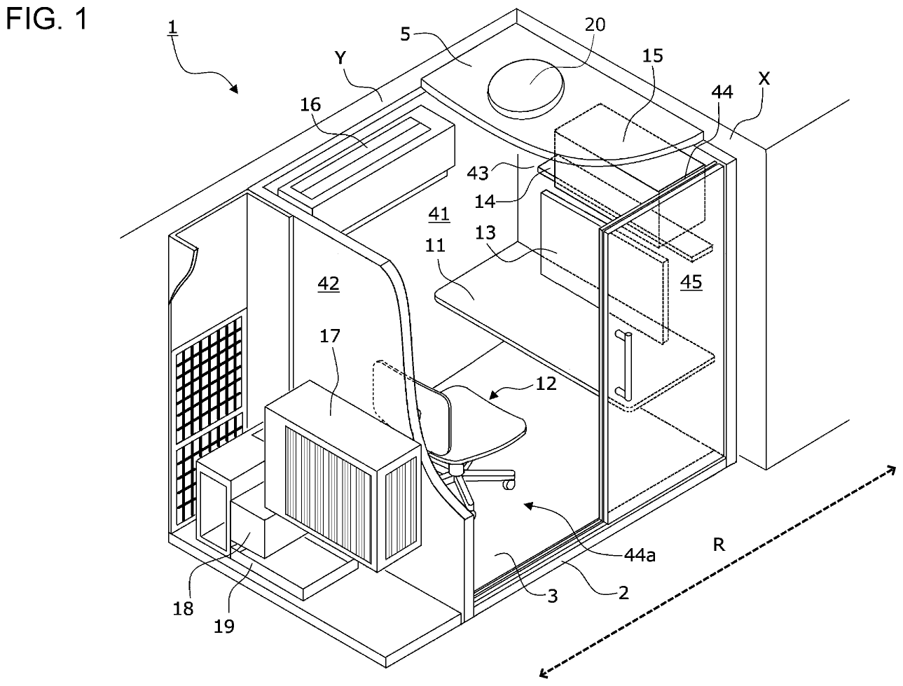

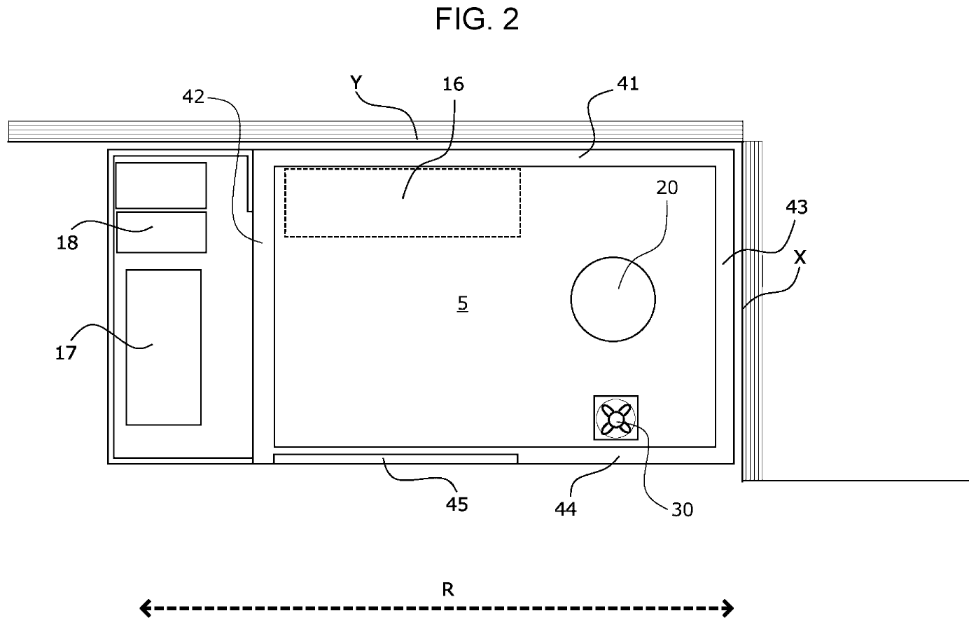

FIG. 1 is a perspective view of a related part of the inner configuration of a booth 1 according to the present exemplary embodiment. FIG. 2 is a plan view illustrating how the booth 1 is installed. Hereinafter, the overall configuration of the booth 1 will be described with reference to the drawings.

As FIGS. 1 and 2 illustrate, the booth 1 has a box shape as a whole. A desk 11, a chair 12, a monitor 13, a light 14, an electrical component box 15, and an air-conditioning indoor unit 16 of an air conditioner are disposed in an inside space, and an air-conditioning outdoor unit 17 of the air conditioner is disposed in a side space. In the air-conditioned space formed in the booth 1, while sitting on the chair 12, a user is able to conduct various activities such as work and study at the desk 11 and in front of the monitor 13 and is able to obtain online services via a telecommunication line.

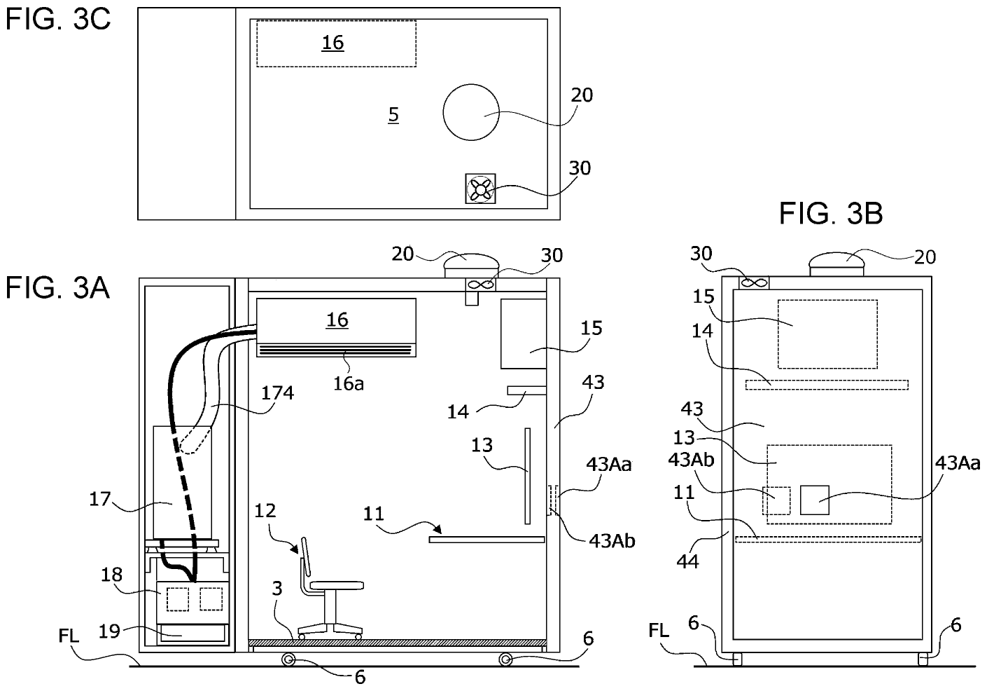

The booth 1 has a foundation portion 2 disposed on an installation surface FL, a floorboard portion 3 disposed on the foundation portion 2, a side-wall panel 4 arranged vertically on the foundation portion 2, a top panel 5 disposed on the side-wall panel 4, and casters 6 (refer to FIGS. 3A and 3B) disposed on a lower portion of the foundation portion 2.

The foundation portion 2 is formed by joining four beam members to one another so as to form a rectangular shape corresponding to a bottom shape of the booth 1, and the foundation portion 2 is constituted by, for example, rectangular steel tubes.

The floorboard portion 3 is in contact with and supported by a floor-supporting member protruding inward relative to the foundation portion 2. For example, the floorboard portion 3 is formed of structural plywood, which is a wooden board member, on which a floor mat is layered.

The side-wall panel 4 is constituted by a first side-wall panel 41 that forms a backside wall and has a first face, a second side-wall panel 42 and a third side-wall panel 43 that form a left-side wall and a right-side wall and have a second face and a third face, respectively, and a fourth side-wall panel 44 that forms a front-side wall and has a fourth face. The fourth side-wall panel 44 has an opening 44a that is to be an entrance, and the opening 44a is fitted with a door 45. In the present exemplary embodiment, the door 45 is a sliding door. In addition, an electronic lock (not illustrated), which is able to be unlocked by using an electronic key, is attached to the door 45, and it is thereby possible to provide a service such as letting.

The top panel 5 is fixed to an upper end portion of the side-wall panel 4 so as to close an upper opening formed by the side-wall panel 4, and the top panel 5 is constituted by, for example, structural plywood that is a wooden board member.

The casters 6 are disposed at four corners of the lower portion of the foundation portion 2. When the booth 1, which has been assembled in a factory or other sites, is installed at an installation site, the booth 1 is transported by, for example, a truck while placed on the truck bed, and, at the installation site, the booth 1 is installed on the installation surface FL by moving the booth 1 on the casters 6.

In the inside space of the booth 1, the desk 11 is disposed on the floorboard portion 3 so as to be in contact with the third side-wall panel 43 that is on the right side as viewed from the fourth side-wall panel 44. Above the desk 11, the monitor 13, the light 14, and the electrical component box 15 are arranged, in this order, along the third side-wall panel 43 from the lower side to the upper side. The air-conditioning indoor unit 16 is disposed on an upper portion of the first side-wall panel 41 so that an air outlet 16a thereof faces a region from the floorboard portion 3 to the fourth side-wall panel 44.

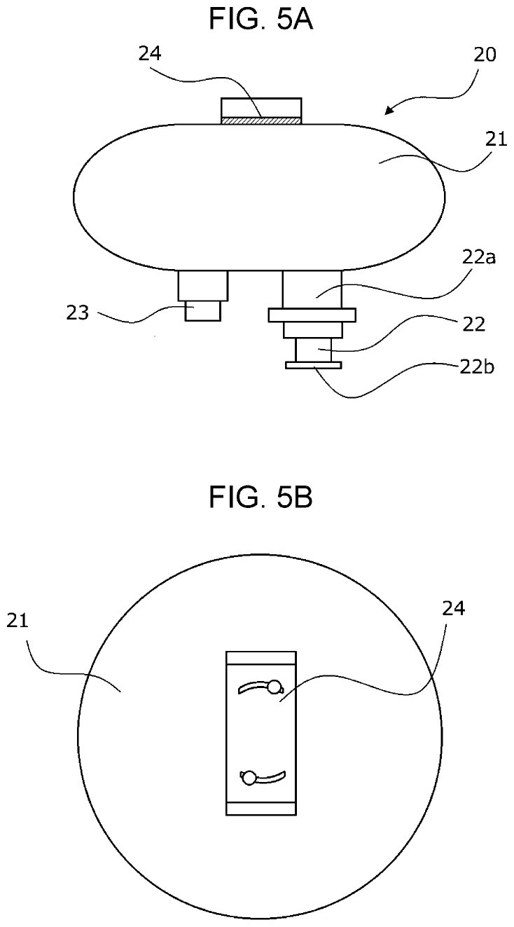

In addition, an automatic fire extinguisher 20 (hereinafter, referred to as a fire extinguisher 20) is attached to the top panel 5. The fire extinguisher 20 has a heat sensor 22b (refer to FIG. 5A) configured to detect a specific temperature, and, when the heat sensor 22b detects an ambient temperature that has reached a predetermined degree, a fire-extinguishing agent is spouted into the inside space of the booth 1.

The air-conditioning outdoor unit 17 connected to the air-conditioning indoor unit 16 of the air conditioner is installed at the outside of the second side-wall panel 42, that is, on the left side as viewed from the fourth side-wall panel 44. Below the air-conditioning outdoor unit 17, an atomizing device 18 that atomizes the condensed water discharged from the air-conditioning indoor unit 16 and the air-conditioning outdoor unit 17 and that discharges the condensed water, which has been atomized, into the atmosphere and a secondary drain pan 19 are arranged, in this order, in the gravitational direction.

The booth 1 configured as described above is able to be assembled in a factory or other sites, transported by, for example, a truck while placed on the truck bed, and installed on the installation surface FL at a predetermined installation site. Examples of such an installation site include an internal corner portion of a building frame as an example of an outside space in which passers-by and users of the booth 1 are mixed together, and the booth 1 may be installed at such an internal corner portion in a concourse space, a passageway, or other spaces formed between a subway station and a location at the ground.

Specifically, as FIG. 2 illustrates, the booth 1 is installed with respect to two wall surfaces: a first wall surface X and a second wall surface Y, which form an internal corner space, so that the third side-wall panel 43 faces the first wall surface X of the internal corner space and the first side-wall panel 41 faces the second wall surface Y of the internal corner space. By the booth 1 being installed in this way, the air-conditioning outdoor unit 17 disposed at the outside of the second side-wall panel 42 is positioned so as not to hinder passers-by from passing (indicated by arrows R in FIG. 1 and FIG. 2) without protruding in a passageway at the installation site of the booth 1.

The installation site is not limited to such an internal corner portion of a building frame, and it is possible to freely dispose the booth 1 in an outside space. In this case, the booth 1 has the inside space formed by the side-wall panel 4 and has the air-conditioning outdoor unit at the outside of one side of the inside space. In plan view, the booth 1 has, as a whole, a rectangular shape having short sides and long sides. The booth 1 may be installed so that the face including the door 45 faces a passageway or a road with heavy foot traffic. The dimensions of the booth 1 in the depth direction, which are to be short sides, are decreased, and it is thereby possible to suppress the booth 1 from protruding toward a passageway so as not to hinder passers-by from passing.

### (2) Air Conditioning System and Fire Extinguisher

### (2.1) Configuration of Air Conditioning System

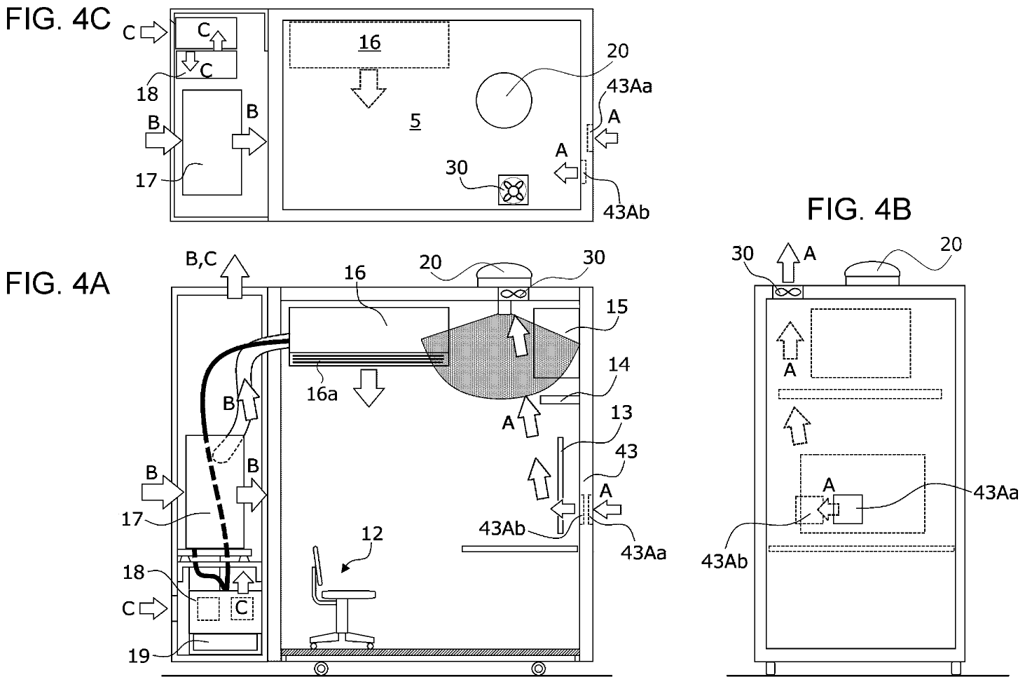

FIGS. 3A to 3C illustrate the booth 1, that is, FIG. 3A is a partially sectional front view of the inner configuration of the booth 1, FIG. 3B is a side view of the booth 1, and FIG. 3C is a plan view. FIGS. 4A to 4C schematically illustrate the air circulation in the entire space of the booth 1.

The booth 1 according to the present exemplary embodiment has the air-conditioning indoor unit 16, the air-conditioning outdoor unit 17, an intake port 43A provided in the third side-wall panel 43 on which the desk 11, the monitor 13, the light 14, and the electrical component box 15 are disposed, and an exhaust fan 30 provided in the top panel 5. In the booth 1, an air conditioning system is formed by the circulation of the cold air or warm air blown through the air outlet 16a of the air-conditioning indoor unit 16 and the flow of the air sucked from the outside through the intake port 43A and discharged by the exhaust fan 30.

As FIG. 3A illustrates, the intake port 43A communicating with the outside is provided in the third side-wall panel 43 disposed on the side on which the monitor 13, the light 14, and the electrical component box 15, as heat sources, are disposed. The intake port 43A is constituted by a first intake port 43Aa provided in the outer surface of the third side-wall panel 43 and a second intake port 43Ab provided in the inner surface of the third side-wall panel 43. In side view, the first intake port 43Aa and the second intake port 43Ab are positioned so as not to overlap one another.

Specifically, in the horizontal direction, the first intake port 43Aa is provided near the center of the third side-wall panel 43, and the second intake port 43Ab is provided on the fourth side-wall panel 44 side relative to the first intake port 43Aa. The first intake port 43Aa may be on the outer side relative to the second intake port 43Ab. In addition, in the vertical direction, the intake port 43A is disposed at a position on the upper side relative to the desk 11 and within a range equivalent to the height of the monitor 13.

As FIG. 3B illustrates, in the top panel 5, the exhaust fan 30 is provided at a position, in plan view, on the third side-wall panel 43 side, which is near the fire extinguisher 20, and near the fourth side-wall panel 44.

Thus, as arrows A indicate in FIGS. 4A to 4C, an airflow is formed in a manner such that outside air is taken in from the back side of the monitor 13 that is one of the heat sources, the air passes through the vicinity of the light 14 and the electrical component box 15 that are the other heat sources, and the air is discharged to the outside through the exhaust fan 30 provided in the top panel 5.

The monitor 13, the light 14, and the electrical component box 15, as the heat sources, are arranged, in this order, along the third side-wall panel 43 from the lower side to the upper side of the space, and the heat from the heat sources may thereby be efficiently discharged outside the booth.

In addition, the air outlet 16a of the air-conditioning indoor unit 16 faces the region from the floorboard portion 3 to the fourth side-wall panel 44, and the air blown through the air outlet 16a does not thereby reach directly the monitor 13, the light 14, and the electrical component box 15, which are the heat sources, and the fire extinguisher 20 disposed at the top panel 5. Thus, while fire-fighting may be promptly started, when a fire breaks out, by the initial heat of the fire reaching the air-conditioning indoor unit 16 (refer to a dotted region in FIG. 4A), a disaster that is caused by a leakage of electricity may be suppressed from occurring by the condensation due to the cold air of the air-conditioning indoor unit 16 being suppressed from occurring.

### (2.2) Disposition of Fire Extinguisher

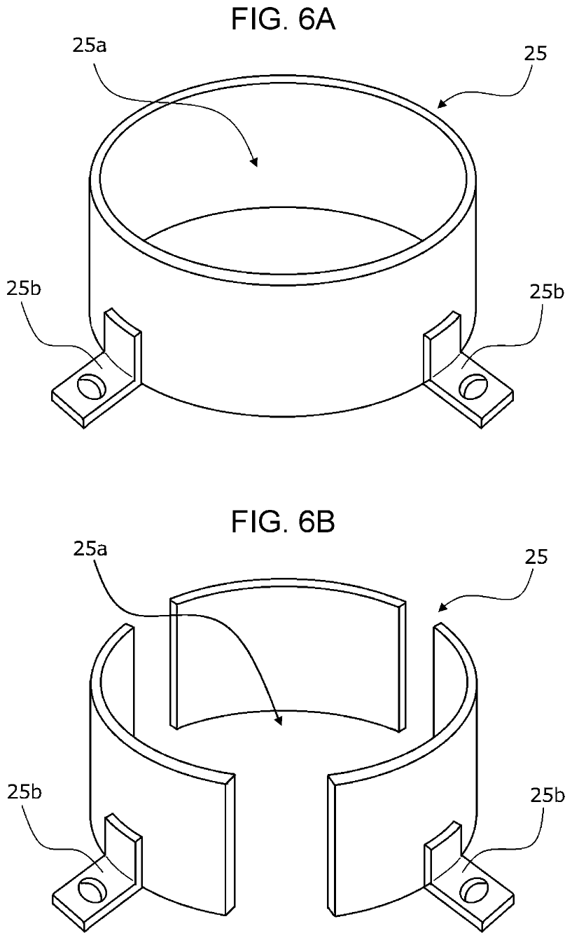

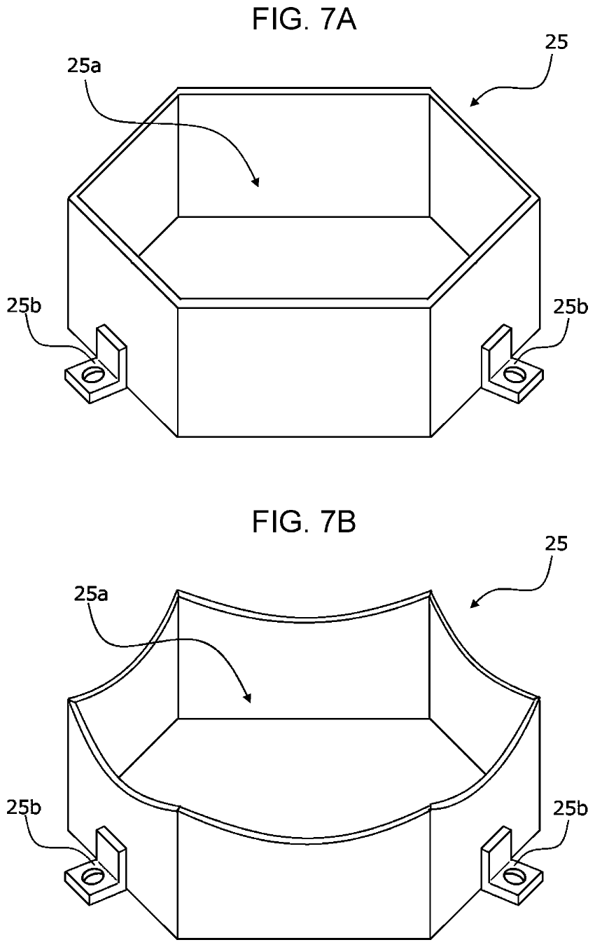

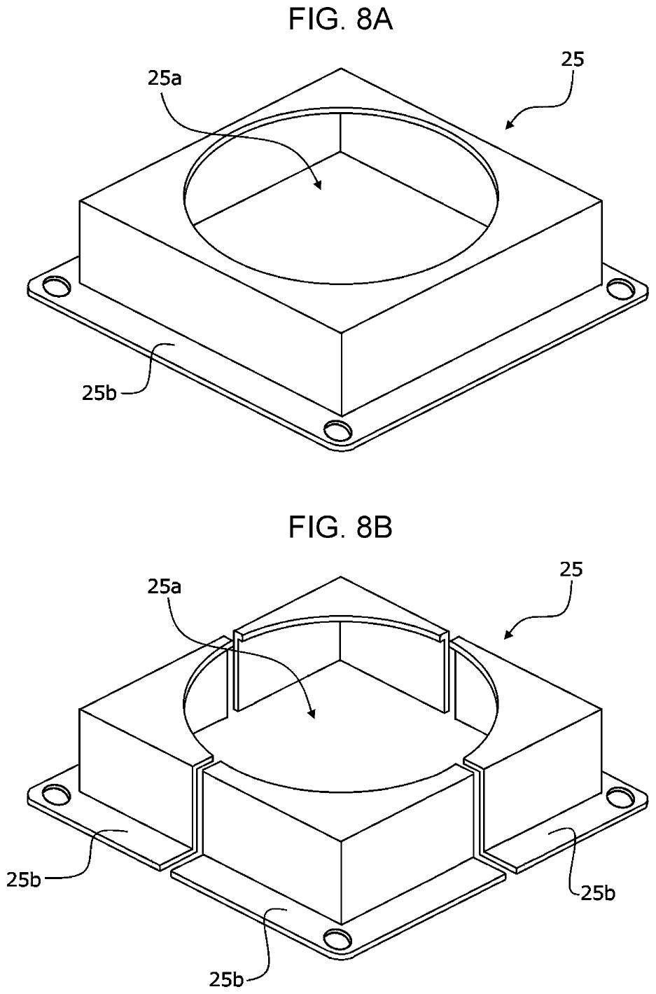

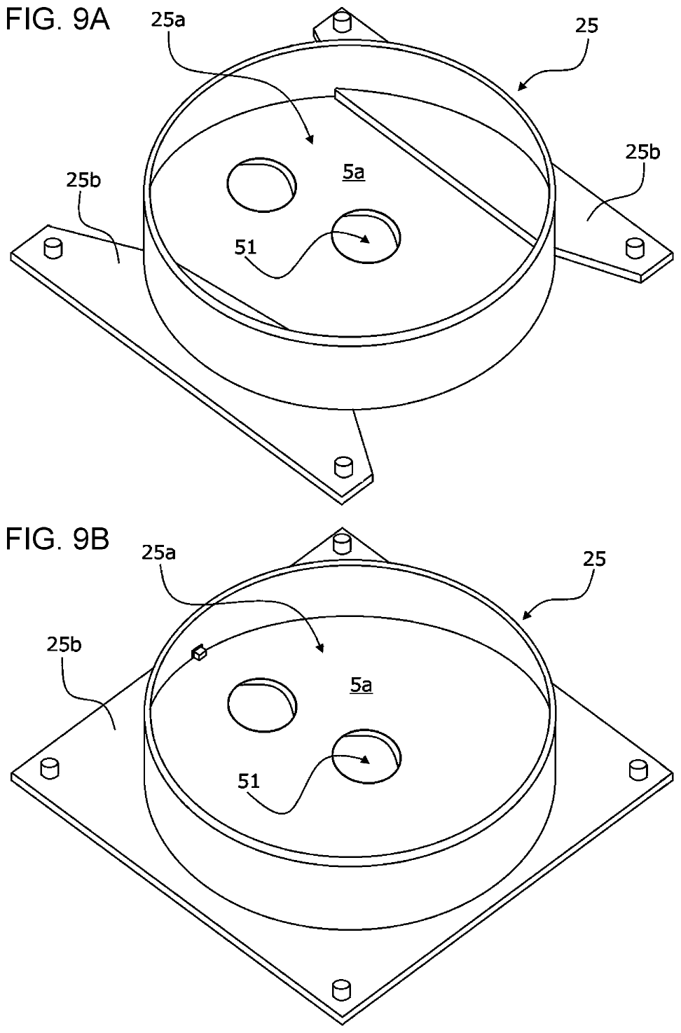

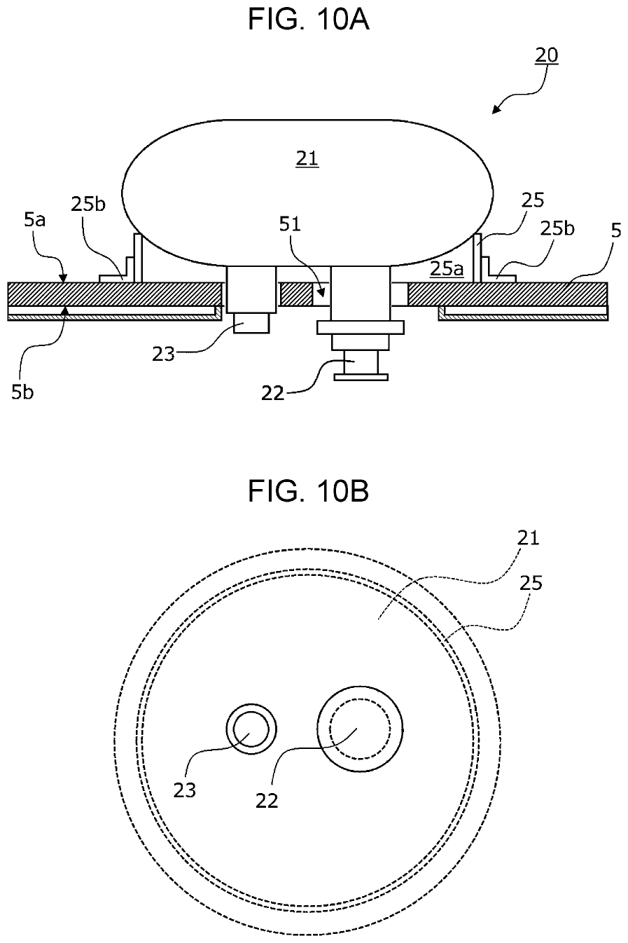

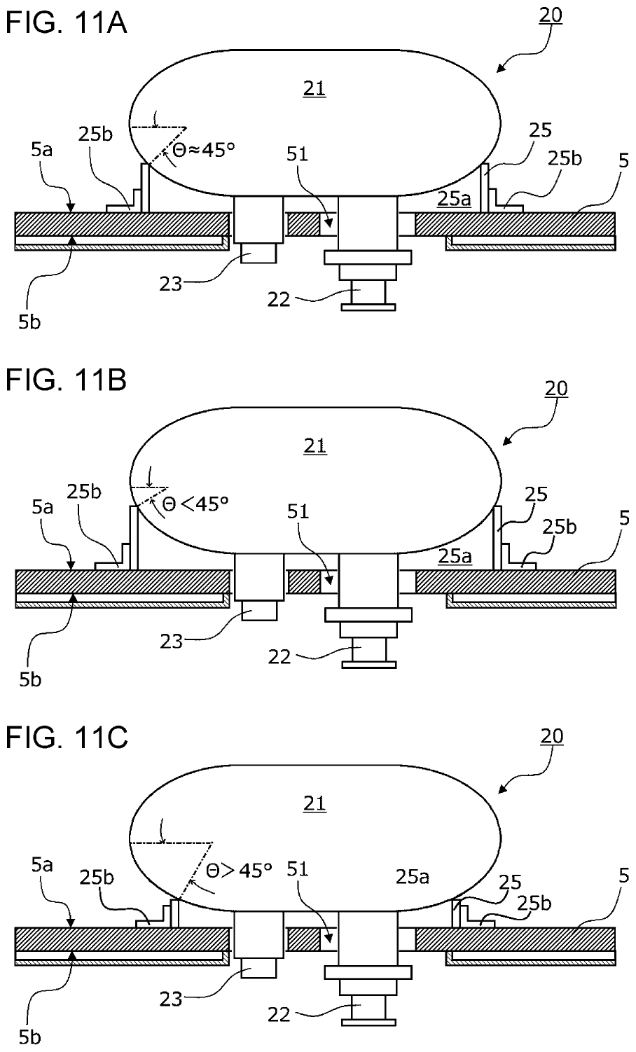

FIGS. 5A and 5B illustrate the structure of the fire extinguisher 20, that is, FIG. 5A is a side view, and FIG. 5B is a plan view. FIGS. 6A and 6B illustrate examples of a hollow cylindrical support tool 25, that is, FIG. 6A is a perspective view of an example, and FIG. 6B is a perspective view of an example of a hollow cylindrical support tool 25 divided into plural portions. FIGS. 7A and 7B illustrate examples of a support tool 25 constituted by a polygonal body, that is, FIG. 7A is a perspective view of an example, and FIG. 7B is a perspective view of another example. FIGS. 8A and 6B are perspective views illustrating box-shaped support tools 25. FIGS. 9A and 9B are perspective views illustrating examples of how the support tool 25 is attached to the upper surface of a ceiling. FIG. 10A and 10B illustrate a structure for fixing the fire extinguisher 20, that is, FIG. 10A is a schematic vertical sectional view, and FIG. 10B is a schematic plan view. FIG. 11A to 11C illustrate the stability of the fixation of the fire extinguisher 20 in relation to the shape of the fire extinguisher main body 21 and the size of the opening of a support tool 25.

Hereinafter, the structures for fixing the fire extinguisher 20 will be described with reference to the drawings.

As FIGS. 5A and 5B illustrate, the fire extinguisher 20 has a shape formed by combining two bowl-shaped objects from above and below. The fire extinguisher 20 has: the fire extinguisher main body 21 storing a fire-extinguishing agent; a fire-extinguishing-agent-spraying nozzle 22 that is positioned below the fire extinguisher main body 21, protrudes downward, and, during a fire, sprays the fire-extinguishing agent stored inside the fire extinguisher main body 21; and the heat sensor 22b that extends from the fire extinguisher main body 21 to a position in the inside space and detects the temperature of the room. The heat sensor 22b is made of a highly thermal-conductive metal. When the heat sensor 22b detects a temperature exceeding a predetermined degree, an end portion of the heat sensor 22b brings a nozzle hole of the fire-extinguishing-agent-spraying nozzle 22 into an open state, and the spray of the fire-extinguishing agent inside the fire extinguisher main body 21 becomes possible.

In addition, a bracket 24 is attached to an upper portion of the fire extinguisher main body 21. The bracket 24 attached to a holding tool 27, which will be described later, provided on the top panel 5.

As FIGS. 10A and 10B illustrate, the fire extinguisher 20 according to the present exemplary embodiment is supported by the support tool 25 from the lower side in the gravitational direction. The support tool 25 is disposed on an upper surface 5a of the top panel 5 so as to surround an opening 51. The support tool 25 has an opening 25a smaller than the maximum outside diameter of the fire extinguisher main body 21 (indicated by Dmax in FIG. 10A) and corresponding to the outside shape of at least a portion of the fire extinguisher main body 21.

As FIG. 6A illustrates, the hollow cylindrical support tool 25 has the opening 25a. The opening 25a corresponds to the outside shape of at least a portion of the fire extinguisher main body 21 so that a portion of the fire extinguisher main body 21 is able to be mounted inside the support tool 25. The support tool 25 has, on a lower end portion thereof, leg portions 25b for fixing the support tool 25 to the upper surface 5a of the top panel 5. In the present exemplary embodiment, the fire extinguisher main body 21 has a round shape formed by combining two bowl-shaped objects from above and below, and the support tool 25 is a hollow cylindrical body so as to receive a lower surface 21a of the fire extinguisher main body 21. However, the support tool 25 may be, for example, divided into plural portions while corresponding to the outside shape of the fire extinguisher main body 21 as FIG. 6B illustrates. Note that FIG. 6B illustrates the example of the division into three portions; however, the support tool 25 may be divided into any number of portions. Costs may be reduced by dividing the support tool 25 into plural portions, compared with the case where the support tool 25 is an integrated hollow cylindrical body.

In addition, the support tool 25 may be a tubular body having, in plan view, a polygonal shape with three or more sides as FIG. 7A illustrates, and such a polygonal tubular body may have a crown shape with each side being recessed as FIG. 7B illustrates. Note that FIG. 7A and 7B illustrate the hexagonal support tool 25; however, a shape having three or more side, that is, for example, an octagonal shape may be possible. As described above, the support tool 25 having such a polygonal tubular shape is in contact with the fire extinguisher main body 21 at points, thereby easily following the outside shape of the fire extinguisher main body 21. In addition, the support tool 25 constituted by a polygonal body may also be divided into plural portions.

Moreover, as FIG. 8A illustrates, the support tool 25 may be a box-shaped body having an annular opening 25a corresponding to the outside shape of at least a portion of the fire extinguisher main body 21. Due to the support tool 25 having a box shape, a leg portion 25b, which fixes the support tool 25 to the upper surface 5a of the top panel 5, is formed as a rectangular face, thereby being able to stably mount the support tool 25 on the upper surface 5a of the top panel 5.

In addition, for example, the support tool 25 may be divided into plural portions while corresponding to the outside shape of the fire extinguisher main body 21 as FIG. 8B illustrates. Costs may be reduced by dividing the support tool 25 into plural portions, compared with the case where the support tool 25 is an integrated box-shaped body.

In addition, as FIG. 9A and 9B illustrate, in a state of being mounted on the top panel 5, the support tool 25 may be formed so that a leg portion 25b juts outward from the tubular body without an edge portion of the opening 25a overlapping and closing the opening 51 formed in the upper surface 5a of the top panel 5. Thus, the support tool 25 may be stably mounted on the upper surface 5a of the top panel 5.

In addition, a portion of the upper surface 5a may protrude so as to correspond to the outside shape of the fire extinguisher main body 21, or a hollow may be provided so that the fire extinguisher main body 21 fits therein. It goes without saying that, in addition to such partial processing on the upper surface 5a, a fire-extinguishing container may be stably mounted by using support tools in combination. By doing so, due to an increase in the number of support portions formed as part of the upper surface, the number of components may be reduced, and the number of man-hours for installation may thereby be reduced.

FIGS. 11A to 11C illustrate the stability of the fixation of the fire extinguisher 20 in relation to the shape of the fire extinguisher main body 21 and the size of the opening 25a of the support tool 25.

The fire extinguisher main body 21 has a container shape whose outside shape has a curvature. As FIG. 11C illustrates, the fire extinguisher main body 21 is further stably held by the support tool 25 when the size of the opening 25a of the support tool 25 is reduced to a minimum (0>45 degrees). On the other hand, however, the appearance is impaired when the support tool 25 is small. In contrast, as FIG. 11B illustrates, although the appearance is improved when the size of the opening 25a of the support tool 25 is increased (0<45 degrees), the fire extinguisher main body 21 is not stably held because a portion of the fire extinguisher main body 21 having a larger outside size has a larger curvature.

In the present exemplary embodiment, as FIG. 11A illustrates, it is intended to balance the stability of the fire extinguisher main body 21 and good appearance by setting the size of the support tool 25 so that an angle θ formed by a horizontal line and a normal line N at a contact portion between the outside shape of the fire extinguisher main body 21 and the support tool 25 is approximately 45 degrees.

### Modification 1

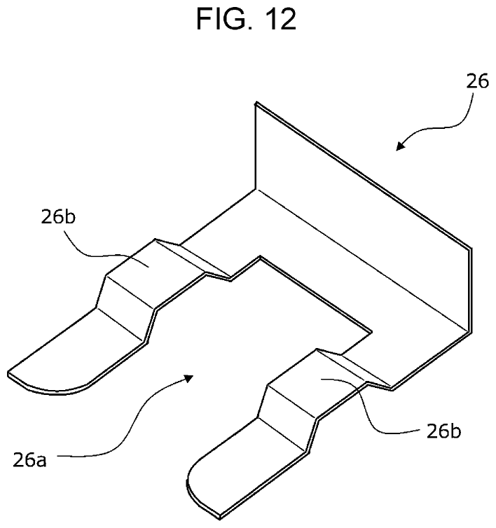

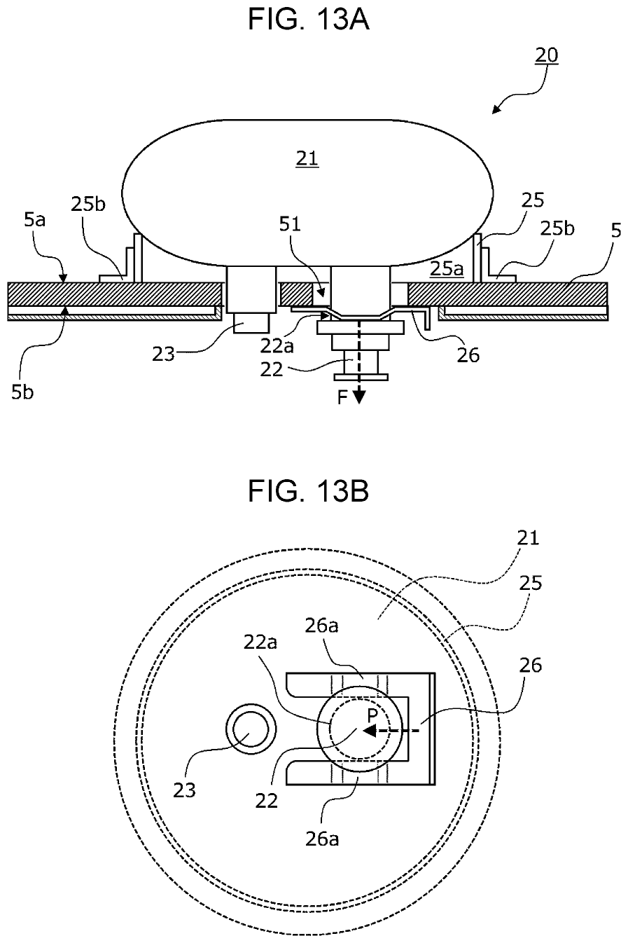

FIG. 12 is a perspective view of an example of a fixing tool. FIG. 13A and 13B illustrate a structure for fixing the fire extinguisher 20, according to Modification 1, that is, FIG. 13A is a schematic vertical sectional view, and FIG. 13B is a schematic plan view.

As FIG. 13A illustrates, the booth 1 according to the present exemplary embodiment has: the support tool 25 that is mounted on the upper surface 5a of the top panel 5 so as to surround the opening 51 and supports the fire extinguisher main body 21 from the lower side in the gravitational direction; and a fixing tool 26 fixing the fire extinguisher main body 21 to the support tool 25 by being slid onto a portion of the fire extinguisher main body 21 at a lower surface 5b of the top panel 5. The fire extinguisher 20 may be fixed while holding the top panel 5 between the support tool 25 and the fixing tool 26.

As FIG. 12 illustrates, the fixing tool 26 has a cutout 26a formed in a plate-shaped body so that the fixing tool 26 is connected to a portion of the fire extinguisher main body 21 and straddles the fire extinguisher main body 21. The fixing tool 26 also has spring portions 26b. The spring portions 26b fix the fire extinguisher main body 21 to the support tool 25 by protruding in a direction intersecting the connection direction of the fixing tool 26 to be connected to a portion of the fire extinguisher main body 21 at the lower surface 5b of the top panel 5.

As FIGS. 13A and 13B illustrate, the fire extinguisher 20 is supported from the lower side in the gravitational direction in a state where a portion of the fire extinguisher main body 21, the fire-extinguishing-agent-spraying nozzle 22, and the heat sensor 22b are accommodated in the opening 25a of the support tool 25 that is fixed to the upper surface 5a of the top panel 5 so as to surround the opening 51 of the top panel 5. From the lower surface 5b side of the top panel 5 toward the opening 51, the fixing tool 26 is slid onto a body portion 22a of the fire-extinguishing-agent-spraying nozzle 22 where a step is formed (refer to arrow P in FIG. 13B), and the spring portions 26b press the lower surface 5b of the top panel 5. By doing so, the fire extinguisher main body 21 is supported at an upper edge portion of the opening 25a and fixed in a state of being pulled in the opening 25a of the support tool 25 (refer to arrow F in FIG. 13A) due to the reaction force resisting to such a pressing force. Thus, the fire extinguisher 20 may be mounted at the top panel 5 of the booth 1 in a simple and removable manner.

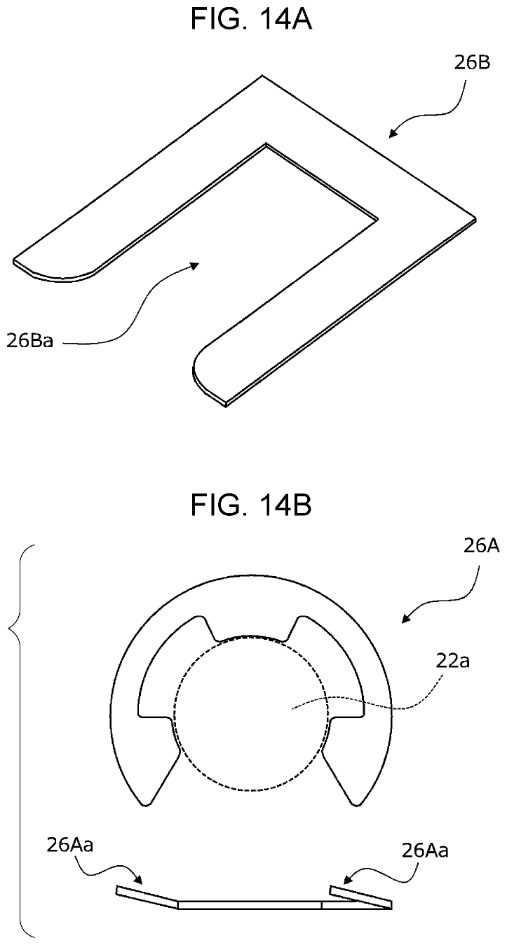

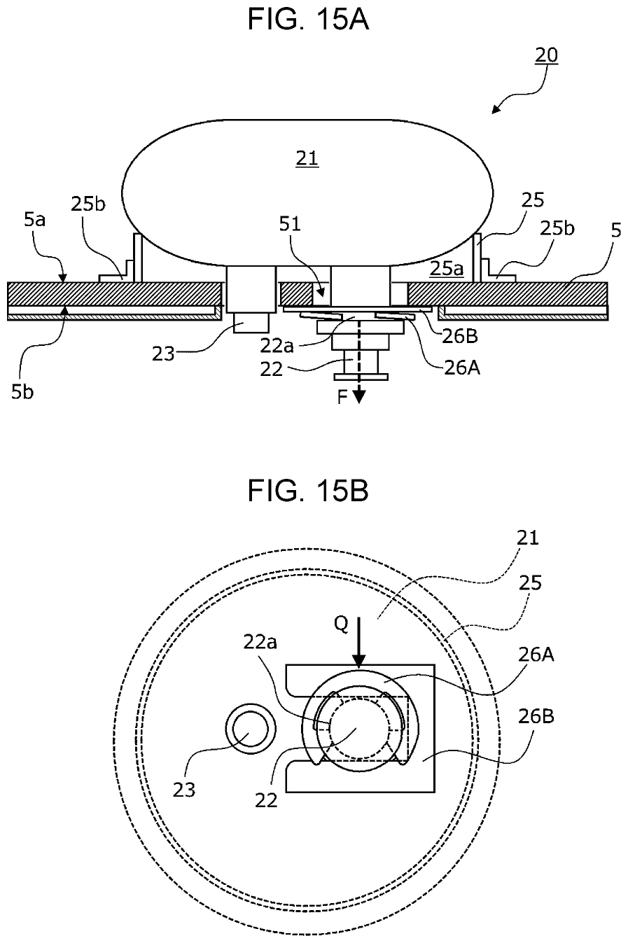

FIGS. 14A and 14B illustrate a spacer 26B as a fixing tool and an E-shaped stopper ring 26A, respectively. FIGS. 15A and 15B illustrate a structure for fixing the fire extinguisher 20 by using the E-shaped stopper ring 26A, that is, FIG. 15A is a schematic vertical sectional view, and FIG. 15B is a schematic plan view.

The fire extinguisher 20 may be fixed by using the E-shaped stopper ring 26A as a fixing tool. Regarding the E-shaped stopper ring 26A, a standardized product according to a shaft diameter is available. In the present exemplary embodiment, the E-shaped stopper ring 26A is selected so as to correspond to the shaft diameter of the body portion 22a of the fire-extinguishing-agent-spraying nozzle 22 where a step is formed, and the fire extinguisher 20 is able to be fixed by the E-shaped stopper ring 26A being slid onto the body portion 22a with the spacer 26B interposed between the lower surface 5b of the top panel 5 and the E-shaped stopper ring 26A.

As FIG. 14A illustrates, regarding the spacer 26B, a cutout 26Ba is formed in a plate-shaped body so that the spacer 26B straddles the body portion 22a, the spacer 26B is formed larger than the opening 51, and the E-shaped stopper ring 26A does not enter the opening 51.

As FIG. 14B illustrates, the E-shaped stopper ring 26A has a spring property so as to press the lower surface 5b of the top panel 5 in a state of being twisted in the thickness direction and being slid onto the body portion 22a with the spacer 26B interposed therebetween.

As FIG. 15B illustrates, from the lower surface 5b side of the top panel 5 toward the opening 51, the E-shaped stopper ring 26A is slid onto the body portion 22a of the fire-extinguishing-agent-spraying nozzle 22 where a step is formed (refer to arrow Q in FIG. 15B), with the spacer 26B interposed between the lower surface 5b and the E-shaped stopper ring 26A, and twisted portions 26Aa of the E-shaped stopper ring 26A press the lower surface 5b of the top panel 5. By doing so, the fire extinguisher main body 21 is supported at the upper edge portion of the opening 25a and fixed in a state of being pulled in the opening 25a of the support tool 25 (refer to arrow F in FIG. 15A) due to the reaction force resisting to the pressing force. Thus, the fire extinguisher 20 may be mounted at the top panel 5 of the booth 1 in a simple and removable manner.

### Modification 2

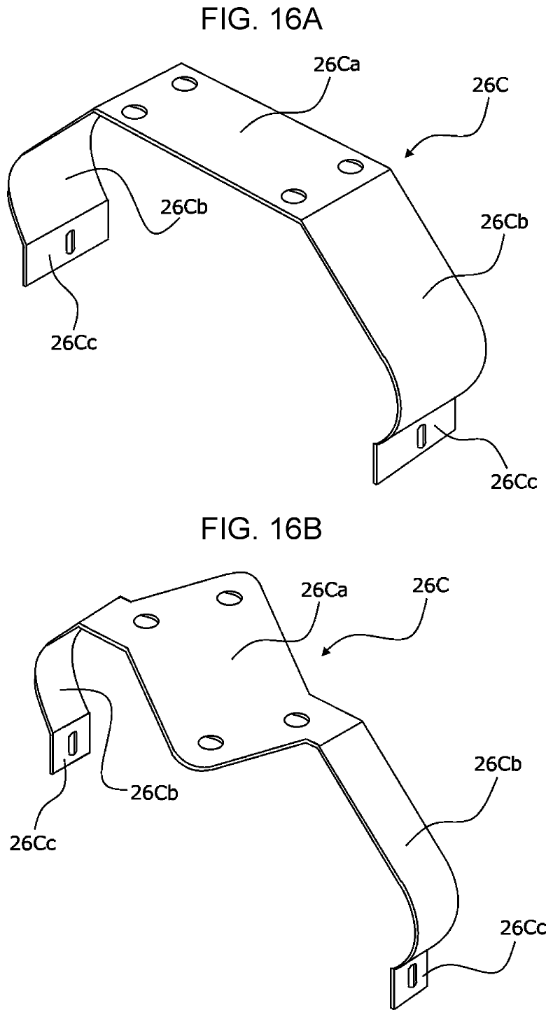

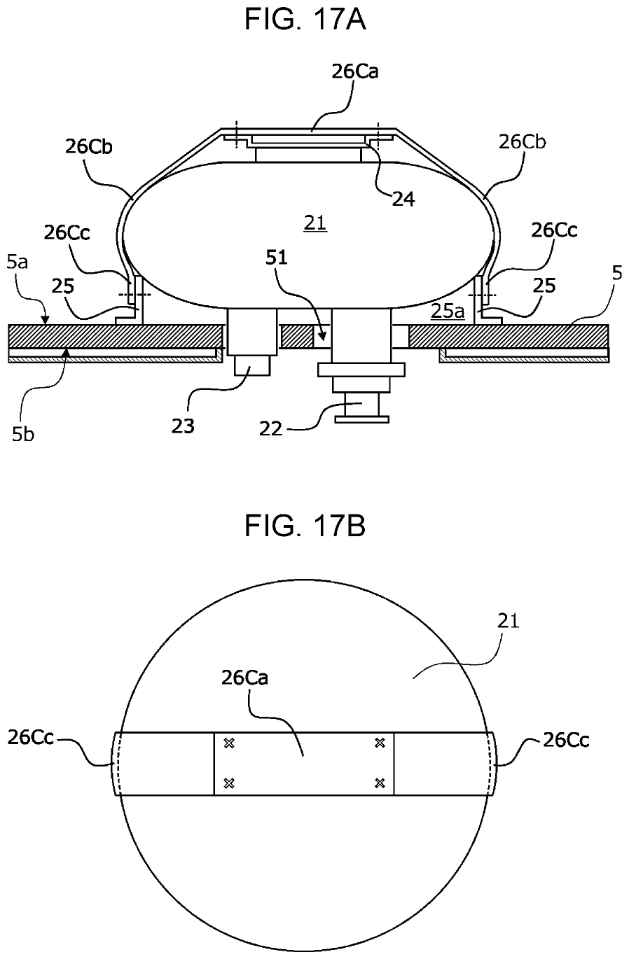

FIGS. 16A and 16B are perspective views of fixing tools 26C according to Modification 2. FIGS. 17A and 17B illustrate a structure for fixing the fire extinguisher 20, according to Modification 2, that is, FIG. 17A is a schematic vertical sectional view, and FIG. 17B is a schematic plan view.

As FIGS. 17A and 17B illustrate, in a state of being supported by the support tool 25 that is mounted on the upper surface 5a of the top panel 5 so as to surround the opening 51, the fire extinguisher 20 may be fixed, by using the fixing tool 26C fixing the fire extinguisher main body 21 to the support tool 25, between the support tool 25 and the fixing tool 26C.

As FIGS. 16A and 16B illustrate, each fixing tool 26C has a center portion 26Ca, holding portions 26Cb, and both end portions 26Cc. The center portion 26Ca fixes itself to the bracket 24, which is attached to the upper portion of the fire extinguisher main body 21, so as to hung the bracket 24 from the upper side in the gravitational direction. Each of the holding portions 26Cb is formed so as to follow the outside shape of the fire extinguisher main body 21 and holds the fire extinguisher main body 21. Both the end portions 26Cc are attached to the support tool 25 in a state where the fire extinguisher main body 21 is hung. As FIG. 17A illustrates, regarding the fixing tool 26C, the center portion 26Ca is fixed to the bracket 24 of the fire extinguisher main body 21, and both the end portions 26Cc are fixed to the side surface of the support tool 25. Thus, the fire extinguisher main body 21 may be stably fixed to the support tool 25. Note that the support tool 25 supporting the fire extinguisher main body 21 is not limited to a hollow cylindrical body, may be the support tool 25 constituted by a polygonal body in FIGS. 7A and 7B, and may also be the box-shaped support tool 25 in FIGS. 8A and 8B.

### Modification 3

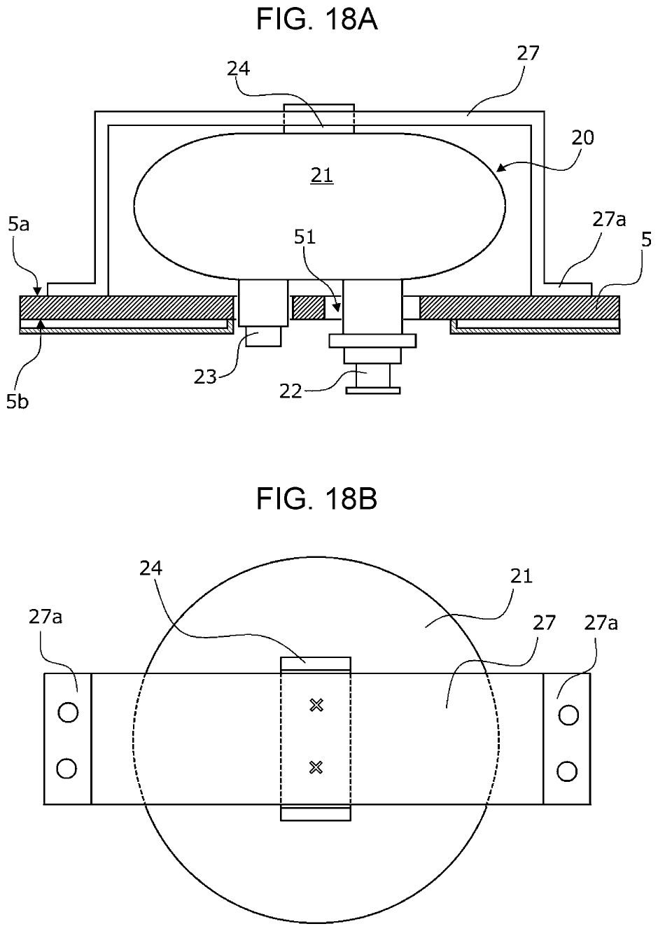

FIGS. 18A and 18B illustrate a structure for fixing the fire extinguisher 20, according to Modification 3, that is, FIG. 18A is a schematic vertical sectional view, and FIG. 18B is a schematic plan view.

As FIGS. 18A and 18B illustrate, the structure for fixing the fire extinguisher 20, according to Modification 3, includes the holding tool 27 extending so as to straddle the opening 51 at the upper surface 5a of the top panel 5 and holding the fire extinguisher main body 21. The holding tool 27 is a bridge body having a size large enough to hold the fire extinguisher 20 in an inner region thereof and is attached to the upper surface 5a of the top panel 5 with leg portions 27a. From the lower side in the gravitational direction, the fire extinguisher 20 is fixed to the holding tool 27 with the bracket 24, which is attached to the upper portion of the fire extinguishers main body 21. Thus, the fire extinguisher 20 may be mounted at the top panel 5 of the booth 1 in a simple manner.

### Modification 4

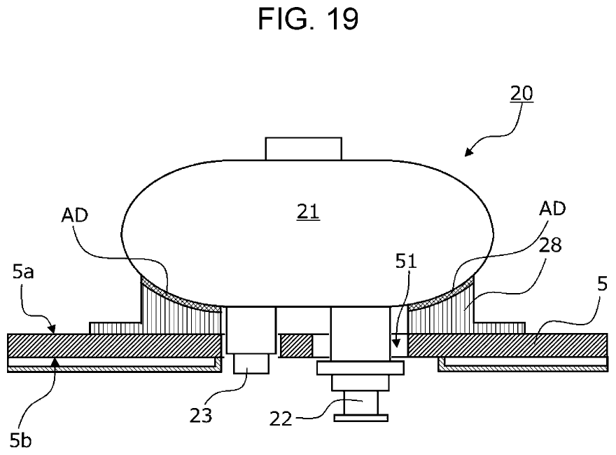

FIG. 19 is a schematic vertical sectional view of a structure for fixing the fire extinguisher 20, according to Modification 4.

As FIG. 19 illustrates, the structure for fixing the fire extinguisher 20, according to Modification 4, includes a holding tool 28. The holding tool 28 is mounted on the upper surface 5a of the top panel 5 so as to surround the opening 51, and the fire extinguisher main body 21 is fixed to the holding tool 28 from the upper side in the gravitational direction. The fire extinguisher main body 21 may be fixed to the holding tool 28 from above by, for example, an adhesive AD being applied to a region between the upper surface of the holding tool 28 and the fire extinguisher main body 21. In place of the adhesive AD, for example, a gel material or a rubber material that has an adhesion property may be used. Thus, the fire extinguisher 20 may be mounted at the top panel 5 of the booth 1 in a simple manner.

### Modification 5

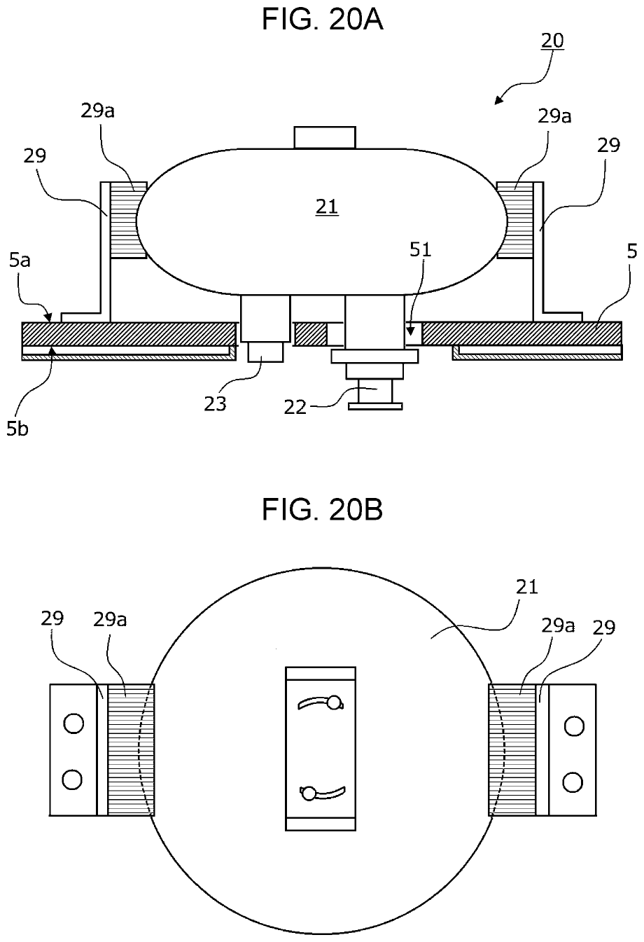

FIGS. 20A and 20B illustrate a structure for fixing the fire extinguisher 20, according to Modification 5, that is, FIG. 20A is a schematic vertical sectional view, and FIG. 20B is a schematic plan view.

As FIGS. 20A and 20B illustrate, the structure for fixing the fire extinguisher 20, according to Modification 5, includes holding tools 29. The holding tools 29 are mounted on the upper surface 5a of the top panel 5 so as to face one another with the opening 51 therebetween, and the fire extinguisher main body 21 is fixed in a state of being accommodated in an inner region of the holding tools 29. The holding tools 29 have respective fixing portions 29a on the inner surfaces thereof and hold the fire extinguisher 20 by the fixing portions 29a fitting with a side portion of the fire extinguisher main body 21 including a flange portion 21a. Each of the fixing portions 29a is a deformable elastic body, and examples of the elastic body include a polyurethane sponge and a silicone rubber. Thus, the fire extinguisher 20 may be mounted at the top panel 5 of the booth 1 in a simple manner.

### Modification 6

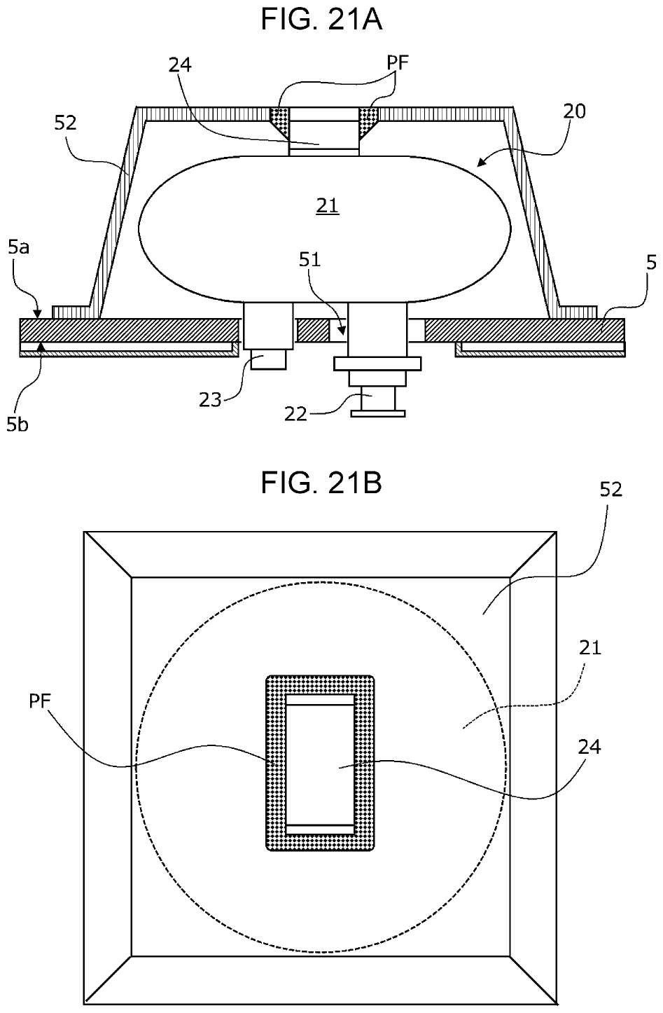

FIGS. 21A and 21B illustrate a structure for fixing the fire extinguisher 20, according to Modification 6, that is, FIG. 21A is a schematic vertical sectional view, and FIG. 21B is a schematic plan view.

As FIGS. 21A and 21B illustrate, the structure for fixing the fire extinguisher 20, according to Modification 6, includes a covering member 52 on the upper surface 5a of the top panel 5. The covering member 52 covers the fire extinguisher main body 21, and the fire extinguisher main body 21 is unremovably attached to the inner surface of the covering member 52 by permanent bonding PF. Examples of such permanent bonding include welding and caulking. In the present exemplary embodiment, the bracket 24 attached to the upper portion of the fire extinguisher main body 21 is bonded to the covering member 52 by welding. Thus, the fire extinguisher 20 may be suppressed from shaking due to the vibration received by the booth 1.

### Modification 7

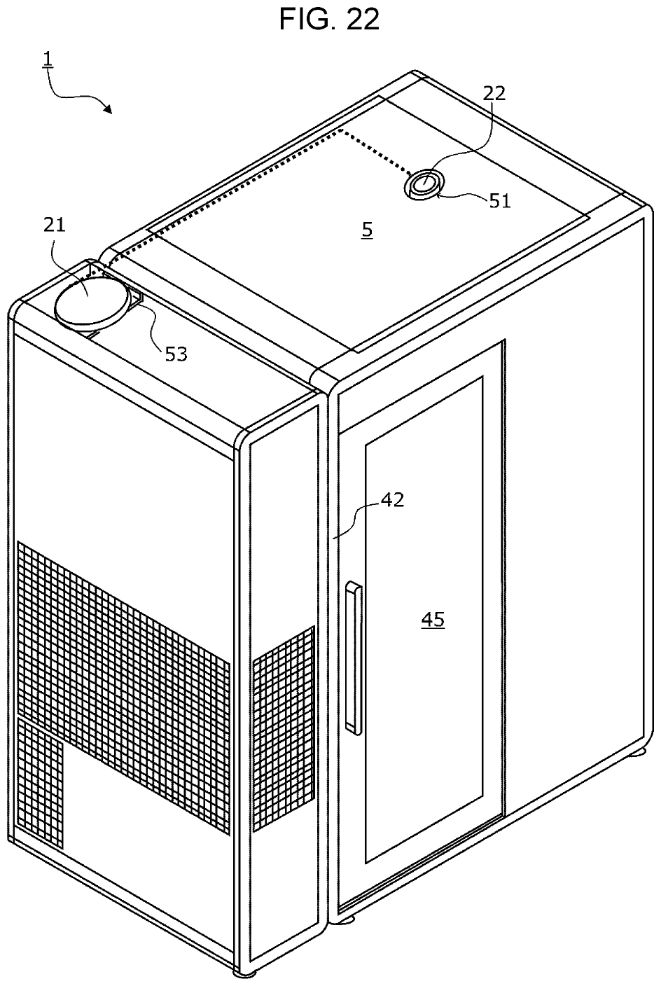

FIG. 22 is a perspective view of a structure for fixing the fire extinguisher 20, according to Modification 7.

In the structure for fixing the fire extinguisher 20, according to Modification 7, the fire extinguisher 20 is disposed in a manner such that the fire extinguisher main body 21 storing a fire-extinguishing agent and the fire-extinguishing-agent-spraying nozzle 22 spraying the fire-extinguishing agent are arranged separately from one another. The fire-extinguishing-agent-spraying nozzle 22 is disposed in the opening 51 of the top panel 5 so as to be directed toward the inner space of the booth 1. The fire extinguisher main body 21 is supported by an attaching tool 53 and disposed in a region apart from the top panel 5 of the inner space, specifically, in a region outside the second side-wall panel 42 and above the air-conditioning outdoor unit 17. By the fire extinguisher main body 21 being disposed in a region apart from the top panel 5 as described above, restrictions on the arrangement position of the fire extinguisher 20 may be reduced.

### (2.3) Surrounding Frame

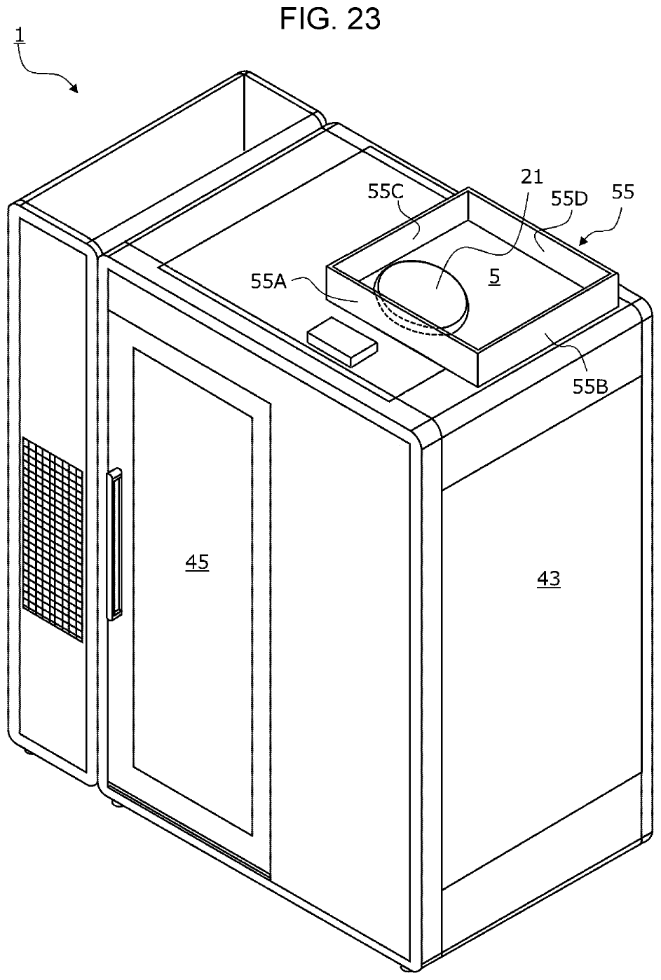

FIG. 23 is a perspective view illustrating the disposition of a surrounding frame 55 of the fire extinguisher 20.

As FIG. 23 illustrates, the surrounding frame 55 surrounding the fire extinguisher main body 21 is arranged vertically on the upper surface 5a of the top panel 5. The surrounding frame 55 is constituted by walls 55A, 55B, 55C, and 55D that are arranged vertically on the upper surface 5a of the top panel 5 in four directions and has an opening at the upper side thereof. By being surrounded by the surrounding frame 55, the fire extinguisher main body 21 having a portion protruding to be exposed at the upper surface 5a of the top panel 5 is not visible from the side on which the booth 1 is accessed, and the appearance of the booth may thereby be prevented from being impaired.

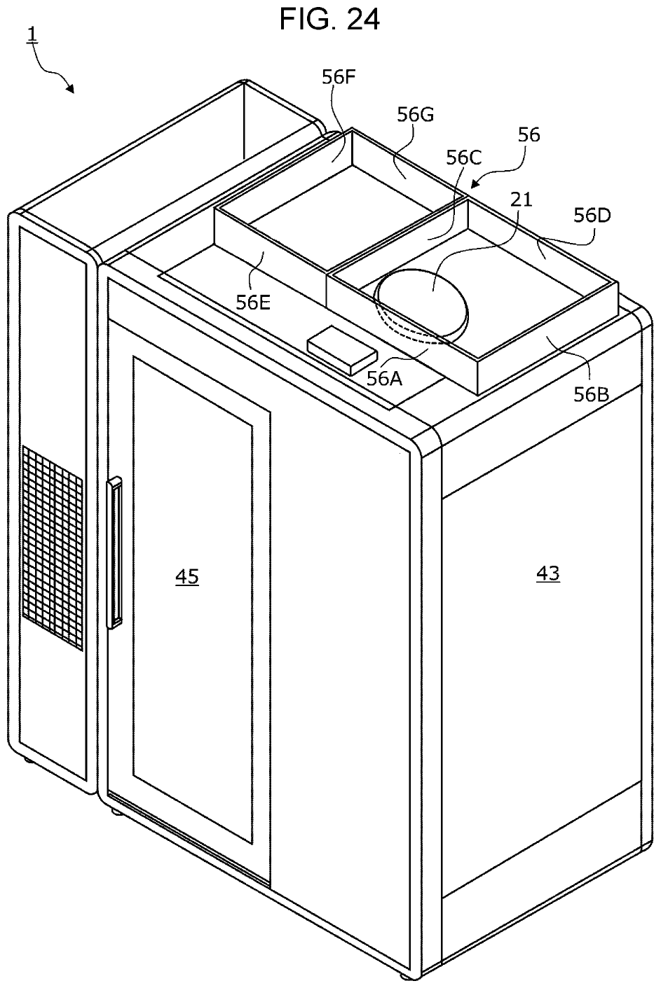

FIG. 24 is a perspective view illustrating the disposition of a surrounding frame 56 of the fire extinguisher 20, according to a modification.

The surrounding frame 56 according to the modification surrounds the fire extinguisher main body 21 and is constituted by walls 56A, 56B, 56C, 56D, 56E, 56F, and 56G that are arranged vertically on and across the substantially entire top panel 5. By the substantially entire top panel 5 being surrounded, even when plural fire extinguishers 20 are installed, the fire extinguisher main bodies 21 are not visible from the side on which the booth 1 is accessed, and the appearance of the booth may thereby be prevented from being impaired.

### (2.4) Covering Member

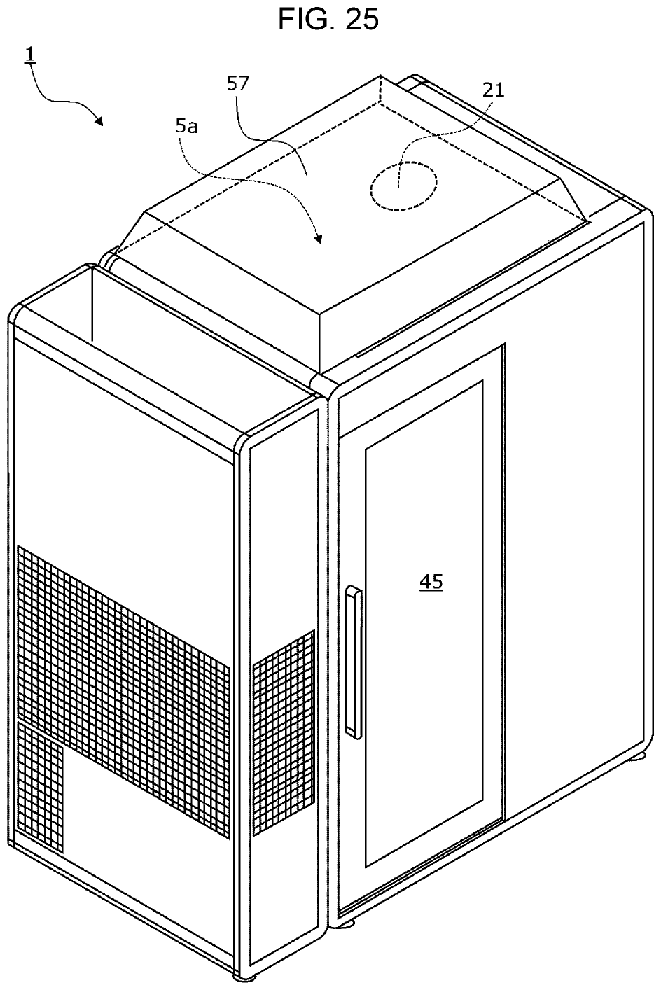

FIG. 25 is a perspective view illustrating the disposition of a covering member 57 covering the fire extinguisher 20.

In place of the surrounding frames 55 and 56, the covering member 57 accommodating the fire extinguisher main body 21 may be disposed on the upper surface 5a of the top panel 5 as FIG. 25 illustrates. The covering member 57 is large enough to be able to accommodate the fire extinguisher main body 21 and covers the upper surface 5a of the top panel 5 without having an opening at the upper side thereof. Thus, while the appearance of the booth 1 may be improved, in particular, installation may be easy. This is because the single covering member 57 is able to cover plural fire extinguisher main bodies 21 with its size large enough to cover the fire extinguisher main bodies 21.

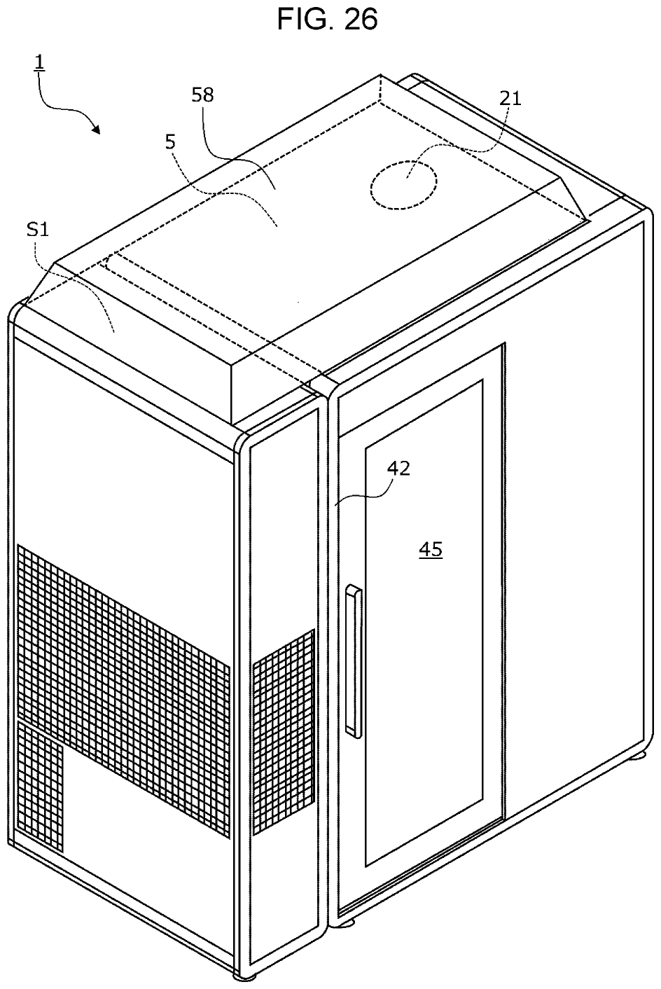

FIG. 26 is a perspective view illustrating the disposition of a covering member 58 covering the fire extinguisher 20, according to a modification.

The covering member 58 according to the modification is large enough to cover the entire top panel 5, which is the upper surface of the inside space, and the upper surface of a space S1 that is adjacent to the inside space and accommodates the air-conditioning outdoor unit 17. Thus, the appearance of the entire booth 1 may be improved.

In the present exemplary embodiment, the booth 1 has the fire extinguisher 20 that is positioned in the opening 51 formed in the top panel 5 and sprays a fire-extinguishing agent into the inside space.

The booth 1 has: the support tool 25 that is mounted on the upper surface 5a of the top panel 5 so as to surround the opening 51 and supports the fire extinguisher main body 21 from the lower side in the gravitational direction; and the fixing tool 26 fixing the fire extinguisher main body 21 to the support tool 25 by being slid onto a portion of the fire extinguisher main body 21 at the lower surface 5b of the top panel 5. The fire extinguisher 20 is fixed while holding the top panel 5 between the support tool 25 and the fixing tool 26. Thus, the fire extinguisher 20 may be mounted at the top panel 5 of the booth 1 in a simple and removable manner.

The surrounding frame 55 surrounding the fire extinguisher main body 21 is arranged vertically on the upper surface 5a of the top panel 5. By being surrounded by the surrounding frame 55, the fire extinguisher main body 21 having a portion protruding to be exposed at the upper surface 5a of the top panel 5 is not visible from the side on which the booth 1 is accessed, and the appearance of the booth may thereby be prevented from being impaired.

The covering member 57, which covers the upper surface 5a of the top panel 5 without having an opening at the upper side thereof, may be disposed on the upper surface 5a of the top panel 5. The covering member 57 accommodates the fire extinguisher main body 21. Thus, while the appearance of the booth 1 may be improved, in particular, installation may be easy. This is because the single covering member 57 is able to cover plural fire extinguisher main bodies 21 with its size large enough to cover the fire extinguisher main bodies 21.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A booth with a ceiling and an inside space, the booth comprising:
a fire extinguisher positioned in an opening portion formed in the ceiling, the fire extinguisher having a fire extinguisher main body storing a fire-extinguishing agent, the fire extinguisher being configured to spray the fire-extinguishing agent into the inside space; and
a support tool disposed on an upper surface of the ceiling so as to surround the opening portion, the support tool having an opening that is smaller than a maximum outside diameter of the fire extinguisher main body and corresponds to an outside shape of at least a portion of the fire extinguisher main body,
wherein the fire extinguisher main body is supported by the support tool from a lower side in a gravitational direction.

2. The booth according to claim 1,
wherein the support tool is one of a hollow cylindrical body, a polygonal body with three or more sides, and a box-shaped body, each of which has the opening corresponding to an outside shape of at least a portion of the fire extinguisher main body so that a portion of the fire extinguisher main body is able to be mounted inside the support tool, and the support tool supports the fire extinguisher main body at an upper edge portion of the opening.

3. The booth according to claim 2,
wherein the support tool is divided into a plurality of portions.

4. The booth according to claim 1, further comprising:
a fixing tool fixing the fire extinguisher main body to the support tool by being slid onto a portion of the fire extinguisher main body at a lower surface of the ceiling,
wherein the fire extinguisher is fixed while holding the ceiling between the support tool and the fixing tool.

5. The booth according to claim 2, further comprising:
a fixing tool fixing the fire extinguisher main body to the support tool by being slid onto a portion of the fire extinguisher main body at a lower surface of the ceiling,
wherein the fire extinguisher is fixed while holding the ceiling between the support tool and the fixing tool.

6. The booth according to claim 3, further comprising:
a fixing tool fixing the fire extinguisher main body to the support tool by being slid onto a portion of the fire extinguisher main body at a lower surface of the ceiling,
wherein the fire extinguisher is fixed while holding the ceiling between the support tool and the fixing tool.

7. The booth according to claim 4,
wherein the fixing tool, which is a plate-shaped body, has a cutout formed in the plate-shaped body so that the fixing tool is connected to the portion of the fire extinguisher main body and straddles the fire extinguisher main body, and the fixing tool has a spring portion fixing the fire extinguisher main body to the support tool by protruding in a direction intersecting a connection direction of the fixing tool and by being connected to a portion of the fire extinguisher main body at the lower surface of the ceiling.

8. The booth according to claim 1, further comprising:
a fixing tool having a center portion and both end portions, the fixing tool fixing the fire extinguisher main body to the support tool by the center portion hanging the fire extinguisher main body and by both the end portions being attached to the support tool,
wherein the fire extinguisher is fixed between the support tool and the fixing tool.

9. The booth according to claim 8,
wherein the fixing tool has a holding portion formed so as to follow an outside shape of the fire extinguisher main body and holding the fire extinguisher main body.

10. A booth with a ceiling and an inside space, the booth comprising:
a fire extinguisher positioned in an opening portion formed in the ceiling, the fire extinguisher having a fire extinguisher main body storing a fire-extinguishing agent, the fire extinguisher being configured to spray the fire-extinguishing agent into the inside space; and
a holding tool extending so as to straddle the opening portion at an upper surface of the ceiling and holding the fire extinguisher main body.

11. The booth according to claim 10,
wherein the fire extinguisher main body is fixed to the holding tool from a lower side in a gravitational direction.

12. The booth according to claim 10,
wherein the fire extinguisher main body is mounted on and fixed to the holding tool from an upper side in the gravitational direction.

13. The booth according to claim 10,
wherein the fire extinguisher main body is fixed in a state of being accommodated in an inner region of the holding tool.

14. The booth according to claim 1, further comprising:
a surrounding frame surrounding the fire extinguisher main body, the surrounding frame being arranged vertically on the upper surface of the ceiling.

15. The booth according to claim 14,
wherein the surrounding frame is arranged vertically so that the fire extinguisher main body is invisible from a side on which a user for the booth accesses the booth.

16. The booth according to claim 1,
wherein a covering member accommodating the fire extinguisher main body covers the upper surface of the ceiling.

17. The booth according to claim 16,
wherein the covering member is large enough to be able to accommodate a plurality of the fire extinguisher main bodies.

18. The booth according to claim 16,
wherein an air-conditioning device having an air-conditioning outdoor unit is provided,
wherein a space accommodating the air-conditioning outdoor unit is disposed adjacent to the inside space, and
wherein the covering member is large enough to cover the entire upper surface of the inside space and an upper surface of the space adjacent to the inside space.

19. A booth with a ceiling and an inside space, the booth comprising:
a fire extinguisher configured to spray a fire-extinguishing agent into the inside space,
wherein the fire extinguisher has
a fire extinguisher main body storing the fire-extinguishing agent, and
a spraying nozzle configured to spray the fire-extinguishing agent, and
wherein the fire extinguisher main body is mounted in a region apart from the ceiling of the inside space.

20. A booth with a ceiling and an inside space, the booth comprising:
a fire extinguisher positioned in an opening portion formed in the ceiling, the fire extinguisher having a fire extinguisher main body storing a fire-extinguishing agent, the fire extinguisher being configured to spray the fire-extinguishing agent into the inside space; and
a covering member disposed on an upper surface of the ceiling and covering the fire extinguisher main body,
wherein the fire extinguisher main body is attached to an inner surface of the covering member by permanent bonding.
